(19) United States
(12) Patent Application Publication
(10) Pub. No.: US 2004/0264475 A1
(43) Pub. Date: Dec. 30, 2004

(54) Class of high throughput MAC architectures for multi-channel CSMA systems

(75) Inventor: John Michael Kowalski, Camas, WA (US)

Correspondence Address: Robert D. Varitz, ROBERT D. VARITZ, P.C., 2007 S.E. Grant Street, Portland, OR, 97214, US

(73) Assignee: The Nature of the conveyance

(21) Appl. No.: 10/778,644

(22) Filed: Feb. 12, 2004

Related U.S. Application Data
(60) Provisional application No. 60/484,474, filed on Jun. 30, 2003.

(51) Int. Cl. H04L 12/28

(52) U.S. Cl. 370/395.5

(57) ABSTRACT

An architecture for multi-channel CSMA systems using an 802.11 protocol includes a MAC for each a station, wherein each MAC includes plural transmit queues, a queue selection mechanism, and a holding queue; a physical layer having multiple channels therein; and a receiver for each station, each receiver having a re-ordering buffer for ordering packets in a proper sequence prior to the packets leaving the receiver. A method of providing high throughput in an 802.11 CSMA system includes selecting an optimum transmission route for a packet to be transmitted, including: selecting an optimum transmit queue; selecting an optimum channel in the physical layer; and transmitting the packet over the optimum transmission route.

### RELATED APPLICATION

This Application claims priority from U.S. Provisional Patent Ser. No. 60/484,474, for Methods and Systems for Multi Channel CSMA Systems, filed Jun. 30, 2003.

### FIELD OF THE INVENTION

This invention relates to wireless communication, and specifically to a CSMA system having multi channel stations therein.

### BACKGROUND OF THE INVENTION

The current 802.11 architecture, based on Carrier-Sense Multiple Access (CSMA), has inherent limits in capacity on a single channel because back-offs, which are the times an 802.11 station must wait on detection of a collision, or after a successful transmission. This back-off must occur when a channel is detected as being busy. Additionally, radio transients further limit capacity to a lesser degree because the detection time is a function of signal-to-noise ratio and there is a time below which detection of a busy channel cannot be practically done. The only way to resolve this capacity problem and to keep the current access paradigm is to provide “multiple radios in parallel.” Further, because there is a need for backwards compatibility in 802.11 radios; next generation radios must support backwards compatible modes in order to maintain connectivity.

Multiple channel radio architectures are a natural means for providing higher throughput for CSMA systems, so long as the MAC “is aware” of these multiple radio channels.

The FCC has indicated that they are going to open up more spectrum for unlicensed usage, and that so-called “cooperative radio technology,” wherein wireless LANs may be used in channels in which there are other primary users, will become the norm. While multiband 802.11 radios exist, their architectures have neither been integrated nor optimized to increase throughput: current multiband radios are more or less “unaware” of each MAC and PHY layer because current multiband radios which meet 802.11 standard are constrained to have multiple association functions. The same is true for multi-channel 802.11 radios, e.g., current radios, e.g., Atheros' “Turbo mode” OFDM, appear to employ multiple channels in a single PHY layer under a single MAC layer.

The following IEEE standards apply to the invention described subsequently herein: 802.11-1999 Standard; 802.11 (e) draft 4.0; and 802.11 h. These standards are available for review on the IEEE website.

Atheros' Dual band 802.11a/b, and 802.11a/b/g Access Points and 802.11a Access Points with “Turbo Mode” provides for access points which all use a single 802.11 legacy MAC, having a single transmit queue. The a/b Access Points may be used as only either 802.11a or 802.11b mode, and thus, do not have integrated association functions,

U.S. Pat. No. 6,580,981, for System and method for providing wireless telematics store and forward messaging for peer- to-peer and peer-to-peer-to-infrastructure a communication network, to Masood et al., granted, Jun. 17, 2003, describes a system and method for sending and receiving messages, such as status or request-for-help messages, automatically between mobile nodes and ultimately to an appropriate destination via a wireless infrastructure. When a node determines that such infrastructure is not available, the node will communicate the necessary information to another mobile node located in, for instance, a vehicle, but does not teach or suggest use of multi-band, multi-channel application of CSMA.

U.S. Pat. No. 6,404,756, for Methods and apparatus for coordinating channel access to shared parallel data channels, to Whitehall et al., granted Jun. 11, 2002, describes a network of nodes communicates using plural, shared parallel data channels and a separate reservation channel. When not engaged in a message transfer on one of the data channels, the primary receiver monitors the reservation channel. If the primary becomes engaged in a message transfer, the secondary receiver is activated and monitors the reservation channel. Use of the secondary receiver avoids loss of channel access information resulting from use of a single receiver for both the reservation and data transfer mechanisms. By transmitting requests for channel access on the reservation channel and continuously monitoring the reservation channel, message collisions are dramatically reduced. The reference does not teach or suggest the use of a multiplicity of 802.11 channels, which allow SLG1 for both legacy stations and higher throughput stations to simultaneously use a number of channels, thereby providing higher throughput and backwards compatibility, nor does the reference teach or suggest the use of multiple queues to achieve a system objective function (minimum delay, equal delay, minimum packet error, etc.

U.S. Pat. No. 6,393,261 for Multi-communication access point, to Lewis, granted May 21, 2002, describes provision of an access point for use in a wireless network having a system backbone and a plurality of mobile terminals. The access point includes a communication circuit coupling the access point to the system backbone, and a first transceiver for wirelessly communicating with at least one of the plurality of mobile terminals on a first communication channel. In addition, the access point includes a second transceiver for wirelessly communicating with at least another of the plurality of mobile terminals on a second communication channel different from the first communication channel. The reference does not teach or suggest simultaneous multiple channel transmission from a single mobile terminal; simultaneous multiple transmit queues to achieve a criteria such as equal delay, equal load, etc., and does not envision the use of multiple disparate PHY layers, e.g., legacy 802.11 CCK+legacy 802.11a, being simultaneously used.

U.S. Pat. No. 6,370,381, for Multiple channel communications system, to Minnick et al., granted Apr. 9, 2002, describes a multi-channel communications system for communications between a mobile units and dispatch agencies through tower sites under control of a multi-channel communication controller. The method of communications used is time division multiple access with provisions for alternate methods. The mobile units and dispatch agencies have forms of identifications to route messages between the mobile units and dispatch agencies according to the forms of identification. The forms of identification are resolved from one form to another to operate with the alternate methods of communications. The mobile units are handed off from one communications channel to another by the multi-channel controller as channel loading conditions exceed a predetermined limit. The reference does not teach or suggest a wireless system that is able to associate legacy traffic and provide queuing into multiple channels based on information supplied by the stations via its capability information.

U.S. Patent Publication No. 20030114153 A1 for Universal broadband home network for scalable IEEE 802.11 based wireless and wireline networking, of Shaver et al., published Jun. 19, 2003, describes integrated transport for power line, Ethernet & WLAN, but dose not describe multi-band, multi-channel systems integrated into a single MAC.

U.S. Patent Publication No. 20030107998 A1 for Wireless bandwidth aggregator, of Mowrey, published Jun. 12, 2003, provides a method for transmitting a data stream in a wireless communications network comprising the steps of determining available data bandwidth in the wireless communications network so long as sufficient available data bandwidth exists, then partitioning the data stream; and provides a method for dynamically modifying a communication link's data bandwidth comprising the steps of (a) determining available data bandwidth in a wireless communications network, (b) partitioning a data stream into N portions, where N is a number of communications channels such that N* data bandwidth of a single communications channel is less than the determined available data bandwidth, (c) transmitting a k-th portion using a k-th communications channel, where k is a number between 1 and N, and (d) repeating step (c) for all remaining N−1 portions. The publication does not teach or suggest a method of providing a forward compatible method of channel selection, and is not meant to be applicable to 802.11-like wireless LANs, and does not consider the problem of multiple CSMA based transmit queues, nor does the publication consider that the channels involved have different characteristics, and does not teach a method to exploit that issue.

U.S. Patent Publication No. US20030100308 A1 for Device and method for intelligent wireless communication selection, of Rusch et al., published May 29, 2003, describes multiple radio selections, e.g., 3G cell phone, UWB WPAN, and 802.11, however, there is no description of multiple channel/backwards compatibility high throughput extensions to wireless LAN only.

### SUMMARY OF THE INVENTION

An architecture for multi-channel CSMA systems using an 802.11 protocol includes a MAC for each a station, wherein each MAC includes plural transmit queues, a queue selection mechanism, and a holding queue; a physical layer having multiple channels therein; and a receiver for each station, each receiver having a re-ordering buffer for ordering packets in a proper sequence prior to the packets leaving the receiver.

A method of providing high throughput in an 802.11 CSMA system includes selecting an optimum transmission route for a packet to be transmitted, including: selecting an optimum transmit queue; selecting an optimum channel in the physical layer; and transmitting the packet over the optimum transmission route.

It is an object of the invention to provides a multiple channel architecture having individual back-offs per channel/band, thereby providing an increase in channel capacity and throughput for CSMA systems.

Another object of the invention is to provide optimum selecting of channels for transmission based on radio measurements, particularly packet error, queue sizes, and throughput rates according to predetermined criteria.

A further object of the invention is to provide multiple transmit queues in multiple physical channels, within a single association, into access categories.

Another object of the invention is to provide a means to adapt the architecture to new bands as they are approved by regulatory agencies.

Still another object of the invention is to adaptively manage the usage of bandwidth in a distributed manner via specific signaling elements.

Yet another object of the invention is to provide improvements in the time it takes to associate with an access point via staggering beacon messages in time.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the MAC transmit architecture of the invention.

FIG. 2 is a block diagram of a high-throughput MAC receiver of the invention.

FIG. 3—block diagram of the invention.

### DETAILED DESCRIPTION OF THE PREFERRED EMBODIMENTS

The architecture described herein allows for adaptively managing of multi-channel channel access, and “future proofs” the system as new bands are added. The method of the invention duplicates some media access control (MAC) functionality, and provides a means to control duplicated MAC functionalities to optimize capacity. The invention is a MAC architecture for high throughput Carrier-Sense Multiple Access (CSMA) systems, which includes the following features:

1. The use of a multiple channel architecture provides individual back-offs per channel/band, thereby providing an increase in channel capacity and throughput for CSMA systems;

2. The optimum selecting of channels using a queue selection policy for transmission based on radio measurements, particularly packet error, queue sizes, and throughput rates according to various criteria, e.g., minimum delay, minimum packet error, etc.;

3. The mapping of multiple transmit queues in multiple physical channels, within a single association, into access categories, i.e., the ability to provide prioritized Quality of Service (QoS) by mapping transmit queues into priorities across multiple physical channels, thereby maintaining priority differentiation as traffic increases. This allows multiple categories/priorities of traffic to be transmitted simultaneously from a single station, using multiple channels, within a single association to an access point;

4. Adapting the architecture to new bands as they are approved by regulatory agencies;

5. Adaptively managing the usage of bandwidth in a distributed manner via specific signaling elements; and

6. Providing improvements in the time it takes to associate with an access point via staggering beacon messages in time.

The invention anticipates that multi channel/multi-band radios will become the most common means of higher throughput 802.11 transmission. Current radios generally provide a single MAC over a physical layer (PHY). An architecture is described herein which provides multiple transmit queues (TQs) which may be mapped into one or more channels/bands, along with multi-channel channel sensing and network allocation vectors (NAV) for each channel, thereby providing an increase in throughput over and above what might be achieved in a given single channel system.

Description of Architecture.

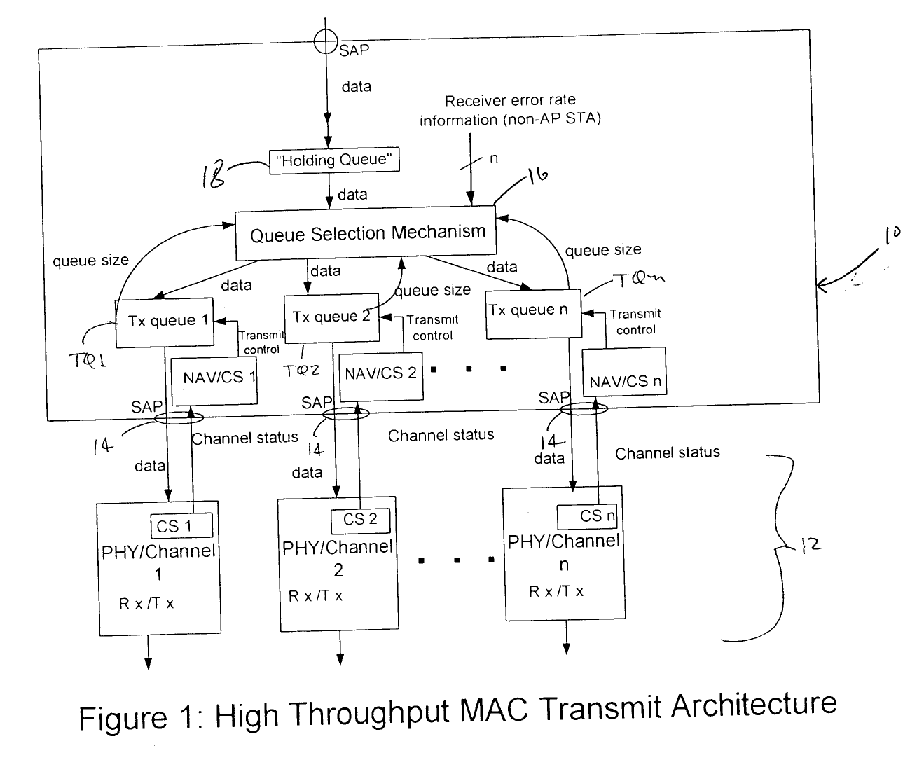

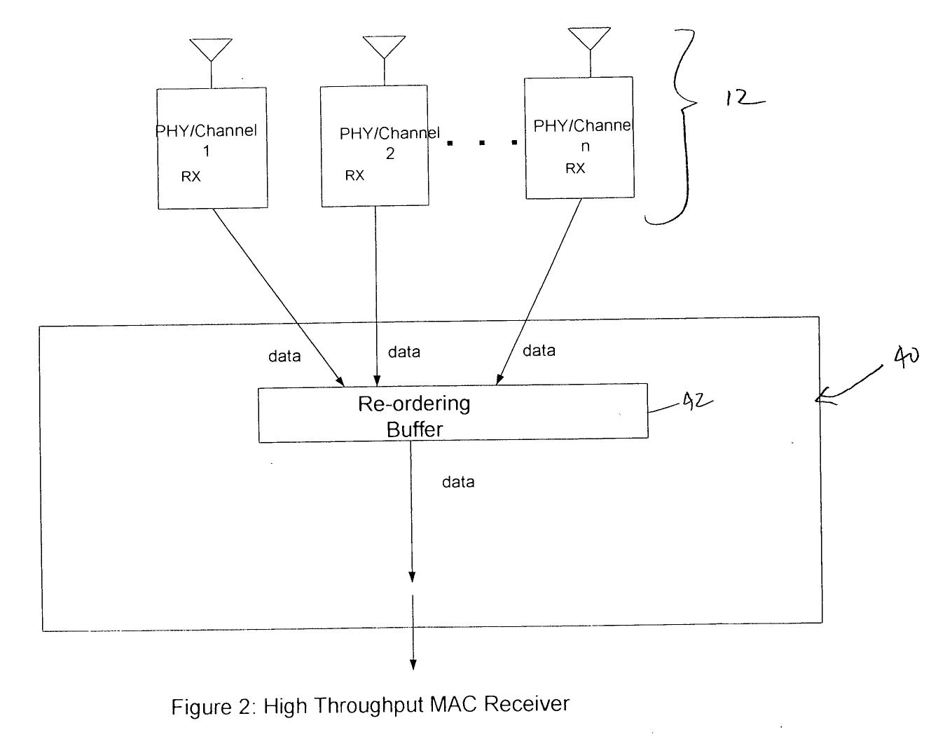

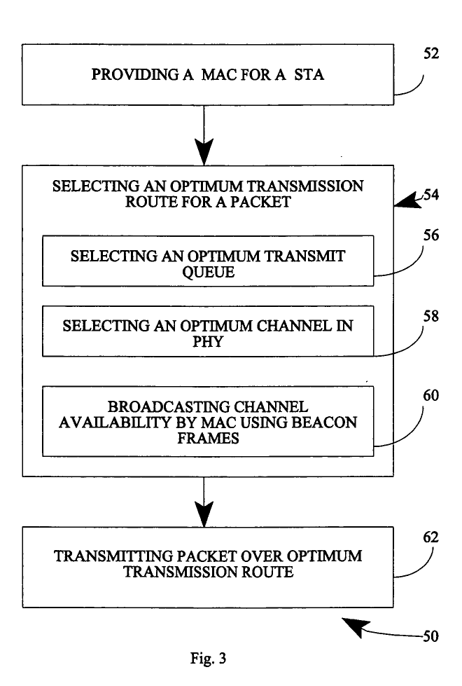

FIG. 1 depicts the architecture for a transmitter of the invention, while FIG. 2 depicts the architecture for a receiver of the invention. FIG. 3 is a block diagram of the method of the invention, depicted generally at 50. Referring initially to FIGS. 1 and 3, a station includes a transmitter having a combined MAC 10 therein, which MAC includes the functions required to support association, i.e., connecting to a basic service set (BSS), the 802.11 equivalent of a “cell” in cellular networks; and security, distribution and integration, the functions involved in connecting to other elements of the network or to an external network. Multiple transmit queues, TQ1, TQ2, . . . TQn, are connected to multiple PHYs, PHY1, PHY2, . . . PHYn, which may be one or more physical RF channels, or multiple channels in a single RF radio, FIG. 3, 52. For example, such channels may comprise one 20 MHz channel at 5 GHz, which is capable of sustaining up to 54 Mbps, or two 20 MHz channels at 5 GHz, which produce an aggregate physical layer data rate of 108 Mbps. The term “channel,” as used herein means either one or more physical channels in single band, or multiple physical channels in multiple bands. As far as the MAC layer is concerned, any “channel,” as defined above, is part of a single physical channel; and the totality of these “channels” represents the physical layer 12, providing PHY services to the MAC. In general, all channels may be part of a single band, or the channels may be partitioned over separate bands of allocated frequencies. There may be more than one RF channel per PHY. As far as the MAC is concerned, these channels are part of a single service access point (SAP) 14, providing a single set of physical layer services to the MAC, albeit from different physical channels. In FIG. 1, SAP 14 is depicted as multiple SAPs extending between each channel and the MAC.

The multiple channels are connected to transmit queues, TQ1, TQ2, . . . TQn, in the MAC. The determination of which channel to use is made by a queue selection mechanism (QSM) 16. The QSM operates according to a queue selection policy (QSP), which is described later herein. The QSM uses information about the stations (STAs) involved in communication; and, in particular, the channels which each STA is using, to determine the “best” queue for use by a station, leading the packet to be transmitted over an optimum rout, including an optimum TQ and an optimum channel in the PHY. The information about which channels are usable by each station is transmitted via, e.g., capability information, or other elements in beacon and probe/probe response frames, as described later herein in the section entitled “Channel Availability, Sensing and Management.”

The functions of association, security, distribution and integration are common to the MAC, and performs substantially as in legacy 802.11 protocols, and are omitted herein for the sake of simplicity and brevity. However, the functions of integration and distribution are required to insure that frames get to the MAC transmit queues. Likewise, data encryption/decryption functions are not shown, as these functions are integrated into a single MAC, as in legacy systems. The use of multiple back-off queues, TQ1 to TQn, for each channel, a reordering buffer (located in each receiver), and channel/band selection provide the optimized method and system of the invention. Also not shown, but required is the legacy function in the MAC receiver which decodes the MAC frame; and in particular, which decodes MAC control frames. These frames include, but are not limited to request to send (RTS), clear to send (CTS) and acknowledgement (ACK) frames. These frames help control the medium access function and retransmission.

The 802.11 wireless LAN protocol uses Carrier Sense Multiple Access/Collision Avoidance (CSMA/CA) for its access mechanism. An important feature of CSMA/CA is that it senses the channel selected by the transmitting station prior to transmission, and if the channel is found to be busy, the STA defers transmission for a pseudo-randomly chosen period of time. In addition, collisions are avoided by having each STA maintain a network allocation Vector (NAV), NAV/CS1, NAV/CS2, . . . NAV/CSn, based on the duration values of frames to be transmitted. In 802.11, the NAV maintains a prediction of future traffic on the medium based on duration information that is announced in RTS and CTS frames prior to the actual exchange of data. RTS/CTS frames allow a station to access the medium in a way that is known to all stations in the BSS. The duration information is also available in the MAC headers of most frames which are sent. The rules on this “virtual carrier sense” mechanism are part of the 802.11 standard.

In FIG. 2, the receiver is shown generally at 40. Because of the characteristics of multiple, different channels used in the invention, and because of the QSP employed in the invention, it is possible that packets may arrive out of sequence; and a re-ordering buffer 42 is required to be transitted by the packets before the packets leave the receiver MAC. Packets may arrive out of sequence because, in general, different numbers of retries of transmitted packets will be required on different channels. The decoding process for the frame is of importance and is done in such a way that the particular channel from which the frame is received is stored and tracked, so that proper acknowledgement, or other control action, may be employed on the appropriate channel as in legacy systems.

The architecture shown in FIGS. 1 and 2 applies, in general, to both Access Point (AP), and non-AP stations.

Channel Access

Referring again to FIGS. 1 and 3, multiple carrier sensing, NAVs, and transmit queues are combined into a MAC 10. Data is routed to each TQ based on QSM 16, 54. QSM 16 determines which TQ, 56, and therefor which channel, 58, to use to transmit a given packet. The carrier sensing for each channel, and each TQ, operates quasi-independently, e.g., RTS/CTS and acknowledgement frames transmitted and received on a given channel affect that channel only. Thus each TQ may be maintained separately, and each carrier sensing mechanism (CSM), which is designated CS1, CS2, . . . CSn, may operate independently of the others.

Data enters the MAC, through a SAP, and is, prior to queue selection, kept in a “holding queue” 18. QSM 16 determines, based on information, e.g., queue length, the rate at which queues are changing, and packet error rate, which TQ will be used by the traffic. It should be noted that, as in 802.11-based CSMA systems, the parameters which govern channel access, and which are related to the transport of traffic on the medium, include the channel back-off ranges and inter-frame spaces. In general, because different bands or modulations may be used in different channels, these parameters will be different in each TQ and in each access mechanism. The actual values of these parameters is chosen in a manner consistent with legacy 802.11 behavior, which is contained in the IEEE standard and is not included herein.

A packet, which is more properly referred to as a MAC service data unit (MSDU), but which is generally referred to by the term packet, is assembled with a header and frame check sum, as is done in legacy 802.11 systems, and remains in the TQ assigned by the CSM, until it is ready to be transmitted. Once transmitted, the frame, if acknowledgement is required, is acknowledged only on the channel upon which the frame is sent. If the frame requiring acknowledgement fails to receive acknowledgment, it is resent on that channel until either (1) successfully received, or (2) its number allowed of retries, i.e., a legacy 802.11 parameter, is met.

Queue Selection

The QSM is affected by the queue size, which is periodically reported from each channel as part of the channel status. The QSM is regularly updated, and may be used to infer a measure of throughput on the given channel for that particular STA. Then queue selection may be made by the QSP based on a number of criteria; among them may be:

1. Equal Delay Criterion: If the (average) queue size in Transmit Queue k is \hat{q}ₖ, and its (average) throughput is \hat{p}_{K}, (>0), the queues may be chosen so that \hat{q}_{K}/\hat{p}_{K} is a constant for all channels. Other, more precise methods of estimating delay, well known to those of ordinary skill in the art, may be used for this purpose as well.

2. QoS Criterion: Some channels may be dramatically better than others and higher priority traffic may be assigned to these channels. Higher priority traffic, in this architecture, may in fact be assigned to a plurality of queues, to enable better access. In an alternate embodiment of the invention multiple queues per channel are provided, with each queue given back-off values and inter-frame spacings required to support prioritized QoS in the manner of the 802.11(e) draft. Thus, a single STA may simultaneously transfer multiple priorities of traffic on multiple channels within a single association to an access point.

3. Minimum Packet Error Criterion: Given that average throughputs, \hat{p}_{K}, are known and measured on the channel, and, for non-access point (non-AP) stations at least, packet error rates may be inferred, packets of differing lengths may be assigned to different queues based on the error characteristic of that queue, with longer packets assigned to better channels, and shorter packets assigned to channels of lesser quality.

4. Next Available Server Criterion: In this embodiment, an additional queue, e.g., the “holding queue,” is provided and located ahead of the QSM. Channel selection is made on the basis of the next available server whose transmit queue is empty.

As an example of the use of these criteria, consider the Equal Delay Criterion: Assume that there is a single transmit queue per channel. Under the Equal Delay Criterion, the CSM makes an estimate of transport time when a packet is delivered to the holding queue: \hat{q}_{K}/\hat{p}_{K} for k=1 to n, where n is the number of transmit queues. The queue selected is that which keeps the delays in all queues closest to a single delay value.

Another example of the use of these criteria considers the Minimum Packet Error criterion: In this case, the AP and the station monitor, through acknowledged packets and the number of retries, determine which queues/channels are favorable, and which are not favorable, for a given communication path or link, which may be non-AP station to AP, AP to non-AP station, or station to station. The AP and the STA then select, dynamically, based on these retry statistics, those queues/channels which are most favorable for transmission, on a link-by-link basis, i.e., the minimum packet error depends on the particular station communicating with a particular station, which may be non-AP station to AP, AP to non-AP station, or station to station. Thus, these retry statistics are dynamically updated, stored and used to select the best transmit queue/channel for transmission. This improves capacity, because fewer retries are needed, and minimize interference from nearby BSSs.

In a manner similar to the Minimum Packet Error Criterion, more favorable queues may be assigned, dynamically, to higher priority traffic, under the QoS Criterion. The Equal Delay Criterion may also be employed with the QoS Criterion, and in such a case, there may be multiple MAC transmit queues per PHY/channel.

The AP, or non-AP station, in the case of a direct-link, involving non-AP station to non-AP station communication, maintains a list of MAC addresses for which all stations are associated, or are in communication, in the case of a direct link. For each STA's MAC address, there is list of available channels for communication, which is initially sent on association, as part of the station's capability information, or in the case of a direct link, on establishment of a Direct Link Protocol connection. This list of channels is used in the QSM to ensure that channels are selected consistent with the channel usage of the stations involved. This list of MAC addresses may also be used to re-queue packets into different TQs if, on the first attempted transmission, the packet is not successfully transmitted, enabling a kind of frequency diversity.

Channel Availability, Sensing, and Management

In addition to the above, the MAC of the AP periodically broadcasts channel availability, so that stations may, if they are capable, use bands with less traffic, and preferably, use bands having the least traffic thereon, FIG. 3, 60. This information may also be obtained from the APs and STAs as a result of a specific inquiry, through so-called “probe” and “probe response” messages.

The invention uses beacon frames, as per legacy 802.11, except that, in the preferred embodiment, they are transmitted on all channels. That is, for each TQ, which is connected to each channel, there is a separate beacon frame. Within these beacon frames there is an element that indicates what other channels are being used. As an example, the 5 GHz band has at present eight channels allocated to it; as a result of recent actions by the FCC this number will probably double. Typically, in legacy 802.11 systems, beacon elements are transmitted approximately every 100 ms. This provides a good tradeoff between the time it takes to associate and channel overhead. In the method of the invention, it is assumed that the beacon interval may be selected for each channel, with a period equivalent to that used in legacy 802.11 systems, e.g., about every 100 ms, to accommodate legacy stations. If no legacy stations are associated, which may be a policy decision of the AP, the beacon interval is shared amongst the channels available, and may be varied to optimize the time to associate and overhead. With the multi-channel architecture described herein, however, beacon elements which are transmitted on different channels may be delayed in time by at least

$$φ = \frac{Nominal Beacon Interval}{Number of Channels}$$

modulo the number of channels. Because of the nature of the wireless medium and the CSMA/CA access scheme, the beacons will, in general, not be precisely synchronized anyway because of packets which arrive at the precise beacon interval. By including the phase, φ, into the beacon sequences, faster association and handoff may be achieved for high throughput stations, while preserving, if legacy stations are associated, the ability for legacy stations to associate on any channel on which they can transmit/receive. Assume, for example, that there are K channels, numbered zero through K-1. If the nominal beacon interval is T, and the beacon on channel k is transmitted at time tₖ, the beacon on channel k+1 is delayed from the beacon on channel k by, on average, φ milliseconds, i.e., the nominal beacon time for channel k+1 is tₖ+φ. Also, the (K-1)^{th} beacon would therefore be in advance of the 0^{th} beacon by φ milliseconds as well.

The channel numbering scheme for 802.11a and 802.11j may be used to denote which channels are being used simultaneously in that band. In addition, another beacon element field is provided to include bands used, as well as yet to be added, to unify the channel numbering that is done in the 2.4 GHz band. This field is signaled in the capability information field in association and probe response messages sent by high throughput stations, to signal which channels the STA is able to use. This allows legacy equipment which may employ multiple bands to associate with the BSS, using only a limited set of bands. As new bands are adopted, it is likely that legacy stations will use only a subset of the number of channels/bands which may be allocated. By employing the method of the invention, a single AP may manage traffic on disparate bands. The form of the element broadcast in each beacon is:

TABLE 1

| | | | | | | | | |
|---|---|---|---|---|---|---|---|---|
| Channel | Number | Band | Channel | Band | Channel | ••• | Band | Channels |
| Elements | of | 1 | numbers | 2 | numbers | | n | used in n^{th} |
| used ID | Bands | | used in | | used in | | (last | band |
| | | | that band | | 2d band | | band) | |

Periodically, dynamic frequency selection is used in some parts of the 5 GHz band in many regulatory domains. This protocol is employed in this system as well, e.g., in the manner proposed for 802.11h.

Stations receive these beacons, and migrate to more useful channels/bands if they are able. However, they are not required to do so, unless they are commanded to do so as a result of the AP detecting a primary user of the band, as done in the current 802.11h protocol, or unless different channels are mapped to different QoS priorities not available to a particular STA. In this way, stations are able to use channels that are of most use to them. This also tends to mitigate inter-BSS interference. The AP keeps track of which channels are available to be used by any station, and provides that information to its QSM, so that each STA may use as many channels as it is able to use. Once the optimal transmission route is selected, the packet is transmitted over the route, 62.

Finally, it should be noted that with the architecture of the invention, if, for example, an 802.11a-like PHY is employed, legacy stations may associate with the AP by only using channels in which they are capable. Legacy stations do not recognize the information elements broadcast on the channel availability, however they still function in a manner that allows them to associate and transport data to the AP or within the BSS.

The APs recognize the existence of legacy traffic and its capabilities from the transmission of the capability information and legacy association messages, as well as from probe/probe response message sequences.

Thus, a high throughput MAC architecture for use in multi-channel CSMA systems has been disclosed. It will be appreciated that further variations and modifications thereof may be made within the scope of the invention as defined in the appended claims.

I claim:

1. An architecture for multi-channel CSMA systems using an 802.11 protocol, comprising:
In a MAC for a station, plural transmit queues, a queue selection mechanism, and a holding queue;
a physical layer having multiple channels therein; and
in a receiver for a station, a re-ordering buffer for ordering packets in a proper sequence prior to the packets leaving the receiver.

2. The architecture of claim 1 which further includes network allocation vectors in each station for avoiding collisions, based on the duration values of frames to be transmitted by the station.

3. The architecture of claim 1 wherein each of said multiple transmit queues is connected to a SAP, which is connected to one of the multiple channels.

4. The architecture of claim 1 wherein said queue selection mechanism determines which channel is to be used for packet transmission, wherein said queue selection mechanism instigates a queue selection policy using information about the stations involved in communication and the channels which each station is using, to determine the best queue for use by a station.

5. The architecture of claim 1 wherein said MAC broadcasts channel availability so that stations in the CSMA system use channels having the least traffic.

6. The architecture of claim 1 wherein said MAC includes plural back-off channels.

7. The architecture of claim 1 which further includes a detector to determine the availability of multiple channels in the CSMA system.

8. A method of providing high throughput in an 802.11 CSMA system, comprising:
providing a MAC for a station, the MAC including plural transmit queues, a queue selection mechanism, and a holding queue; a physical layer having multiple channels therein; and a receiver for a station, the receiver having a re-ordering buffer for ordering packets in a proper sequence prior to the packets leaving the receiver;
selecting an optimum transmission route for a packet to be transmitted, including:
selecting an optimum transmit queue;
selecting an optimum channel in the physical layer; and
transmitting the packet over the optimum transmission route.

9. The method of claim 8 wherein said selecting an optimum transmission route for a packet to be transmitted includes providing a queue selection policy.

10. The method of claim 9 wherein said providing a queue selection policy includes providing criterion for selecting taken from the group of criteria consisting of Equal Delay Criterion; QoS Criterion; Minimum Packet Error Criterion; and Next Available Server Criterion.

11. The method of claim 1 wherein said selecting an optimum transmission route for a packet to be transmitted includes broadcasting channel availability by the MAC using beacon frames transmitted on all channels.
